(19) United States
(12) Patent Application Publication
(10) Pub. No.: US 2023/0182636 A1
(43) Pub. Date: Jun. 15, 2023

(54) VEHICLE LIGHTING DEVICE AND METHOD FOR OPERATING VEHICLE LIGHTING DEVICE

(71) Applicant: FORD GLOBAL TECHNOLOGIES, LLC, DEARBORN, MI (US)

(72) Inventors: Lars Junker, Köln (DE); Stefan Lingscheidt, Köln (DE); Lukas Richter, Köln (DE)

(21) Appl. No.: 17/991,075

(22) Filed: Nov. 21, 2022

(30) Foreign Application Priority Data
Dec. 9, 2021 (DE) 102021132472.6

(51) Int. Cl. B60Q 1/08

(52) U.S. Cl. CPC B60Q 1/08; B60Q 2300/056; B60Q 2300/42

(57) ABSTRACT

A lighting device for a vehicle has at least one headlamp having a plurality of lighting elements which are individually controllable. A method of controlling the lighting device includes detecting an activated state of the at least one headlamp;

detecting a body to be protected from glare; determining a glare suppression angular range based on an extent and position of the body; and determining at least one transition angular range between the glare suppression angular range and a fully illuminated angular range. The light intensity of the glare suppression angular range is set below a specified limit The light intensity of the transition angular range depends on a distance of a beam angle of the individual lighting elements from the glare suppression angular range, wherein the light intensity increases with increasing distance.

### CROSS REFERENCE TO RELATED APPLICATIONS

This application claims priority to application DE102021132472.6, filed in the German Patent and Trademark Office on Dec. 9, 2021, which is incorporated herein by reference in its entirety.

STATEMENT REGARDING FEDERALLY SPONSORED RESEARCH

Not Applicable.

### BACKGROUND OF THE INVENTION

The invention relates to a method for operating a lighting device for a vehicle, such a lighting device for a vehicle, a vehicle having the lighting device, a computer-implemented method, a computer program product, a computer-readable data carrier, and/or a data carrier signal.

Vehicles are usually equipped with lighting devices, such as headlamps. In principle, there is a risk that other road users may be dazzled by glare from the use of the lighting device. This is particularly relevant in the context of the use of main-beam headlamps on motor vehicles. In order to avoid a periodic switching from main-beam to dipped-beam lights, the goal instead is to avoid causing glare to subjects or objects to be protected from glare, in particular other road users, in a targeted manner, for example by only dimming or temporarily switching off individual lighting elements of a headlamp. Examples of this are described in published documents DE102011050535A1, U.S. Pat. No. 11,034,287B2, JP2020029196A, and U.S. Pat. No. 10,793,059B2.

Automotive headlamps are often designed as segmented LED systems, wherein individual LEDs elements are arranged in the form of a matrix or a pixel-based system and are individually controllable to illuminate (project along) different solid angle ranges. Systems are also possible in which a single light source or a group (e.g., of LEDs) or their light outputs are manipulated by means of advanced technologies in such a way that individual regions can be explicitly activated, for example using LCD or DMD technology. In connection with targeted glare suppression, individual lighting elements (for example individual LEDs) are deactivated. To improve the comfort for the human eye, the LEDs to be deactivated can be dimmed. If this dimming or deactivation takes place too slowly, there is a risk of glare. If the dimming or deactivation takes place too fast, however, there is a risk of generating erratic light movements. In principle, a rapid movement (i.e., a rapid change in the light intensity distribution) should be avoided in order not to irritate the road users involved.

### SUMMARY OF THE INVENTION

Against this background, the object of the present invention is to provide an advantageous method for operating a lighting device for a vehicle.

The method according to the invention for operating a lighting device for a is vehicle relates to a vehicle, for example a motor vehicle, a bicycle, a rail-guided vehicle, a ship, or an aircraft, comprising at least one headlamp with a plurality of lighting elements. The light intensity of the individual lighting elements can be controlled individually, i.e., can be controlled (e.g., dimmed) separately for each individual lighting element or independently of one another. In the context of the present invention, a lighting element is understood to mean both a single light source and a light-emitting or radiating region of a light source that can be darkened individually, i.e., independently of other light-emitting or radiating regions of the light source. The individual lighting elements, for example a number of the lighting elements or all available lighting elements, can be arranged side by side, for example in relation to a surface which can be designed as a flat surface or as a curved surface. In particular, a number of lighting elements can be arranged side by side in a horizontal direction.

The method according to the invention may comprise the following steps. In a first step, an activated state of the at least one headlamp is detected. In the next step, a body to be protected from glare, for example an object or subject, in particular another road user such as another vehicle, is detected. This can be carried out by means of suitable sensors, for example a camera, or by means of a signal input from a user. Specifically, the vehicle's surroundings, preferably the area illuminated by the headlamp, can be detected. By means of image recognition and/or by recognition of a lighting device (e.g., a headlamp of another road user), it is possible to determine whether a body that has been detected is a body that should be protected from glare.

Based on a determined extent and position of the detected body, for example a spatial extent or an extent in an irradiation plane, a glare suppression angular range is determined in a further step. A glare suppression angular range is defined here as a beam angular range of the headlamp in which glare is to be suppressed. Furthermore, at least one transition angular range, adjacent to the glare suppression angular range, to a fully illuminated angular range may be determined.

In a further step, the light intensity of the lighting elements illuminating the glare suppression angular range is controlled to a light intensity below a specified is limit In addition, the light intensity of the lighting elements illuminating the transition angular range is controlled to a light intensity which depends on the distance, in particular the angular distance, of the beam angle of the individual lighting element from the glare suppression angular range, the light intensity increasing with increasing distance. The shortest angular distance of the beam angle of the segment (left or right boundary) from the glare suppression angular range (left or right boundary) is always taken into account. In other words, the lighting elements that have a beam angle with a greater distance from the glare suppression angular range have a higher light intensity than the lighting elements that have a beam angle which has a smaller distance from the glare suppression angular range. The method can be applied to different glare suppression angular ranges at the same time independently of each other, e.g. when two vehicles are detected and protected against glare. If this is the case and different transition regions affect the same light segment, an arbitration will take place so that the corresponding segment with the lowest of the calculated intensities is activated.

The advantage of the described method according to the invention is that it enables a smooth transition from a darkened, i.e. glare-suppressed region, to a fully illuminated region, which is pleasant to the human eye. On the one hand, this effectively avoids causing glare to the body to be protected from glare, in particular to other road users, while at the same time improving user comfort. In addition, the method reduces or avoids the undesirable effects described above, which are associated with activating or deactivating individual lighting elements too fast or too slowly. In addition, it avoids the risk of causing glare due to an overlapping of the beam angle of individual lighting elements despite the deactivation of individual lighting elements.

Preferably, the steps of the described method are repeated continuously. This means that both the glare suppression angular range and the transition angular range can be continuously updated, in particular recalculated, and thus adapted to the current traffic situation. As a result, a continuous adjustment of the transition angular range or the light intensity of the affected lighting elements takes place. This is of great importance to the extent that the movement of a glare-suppressed object is continuously taken into account. For example, in the case of an oncoming road user, the actual dimming behavior of the individual segments is implied by the egomotion of the object (i.e., motion resulting from camera motion), since the segments receive a new intensity value with each execution step of the software so that if the execution is sufficiently fast the resulting behavior appears fluid to the human eye. The risk of causing glare to other road users is also minimized, as the activation described here ensures that, assuming the position and extent of an object are correctly identified, a movement of the object cannot result in glare, because if there is a geometric overlapping of a light segment and the object to be glare-suppressed, the light intensity will be below the defined threshold value based on the distance-based logic.

In an advantageous variant, the light intensity of at least one lighting element which illuminates at least one transition angular range is controlled as a function of the minimum angular distance of the beam angle of the lighting element from an angular limit of the glare suppression angular range according to a specified curve. The curve can depend on a specified size of the transition region. For example, the curve can be stretched or compressed. In this way, a transition between a glare-suppressed angular range and a fully illuminated angular range can be created that is more pleasant and in particular non-irritating to the eye of a user.

In an exemplary variant, the transition angular range can comprise at least one first angular range adjacent to the glare suppression angular range and at least one second angular range adjacent to the first angular range in the direction of the fully illuminated angular range. The light intensity of the lighting elements illuminating the first angular range can be controlled to between 10 percent and 50 percent, in particular between 20 percent and 40 percent, of the light intensity of the lighting elements illuminating the fully illuminated angular range and the light intensity of the lighting elements illuminating the second angular range can be controlled to between 50 percent and 90 percent, in particular to between 60 percent and 80 percent, of the light intensity of the lighting elements illuminating the fully illuminated angular range. This variant offers a very simple and resource-conserving implementation of is the idea according to the invention. Preferably, the intensities are variable according to the curves.

The lighting elements are preferably assigned to defined beam angle segments. The beam angle segments can have at least one segment boundary. The light intensity of the lighting elements that are assigned to a common beam angle segment can be controlled as a function of the angular distance of the beam angle segment, for example as a function of the smallest angular distance of the angle segment boundary, from a boundary of the glare suppression angular range, advantageously according to a specified curve. The specified curve can depend on the specified size of the transition region or transition regions.

In another variant, the size of the at least one transition angular range can be adjusted, for example controlled or specified, based on, in particular as a function of, the angular velocity of a change in the position and/or the size of the glare suppression angular range. For example, a first transition region adjacent to a first side of the glare suppression angular range and a second transition region adjacent to a second side of the glare suppression angular range can be determined. The first and second transition regions may differ from each other in their size or extent. This is particularly advantageous when cornering with road users driving ahead and/or in oncoming traffic, as the individual adjustment of the size of the right-hand and left-hand transition regions can be used to provide an optimum illumination of the region where glare is to be suppressed. This method is also advantageous, for example, on straight sections of road, where the transition regions can be defined correspondingly small and thus the total light yield can be maximized. This optimization or adjustment of the transition angular range takes place continuously.

The lighting device according to the invention for a vehicle, in particular a vehicle mentioned above as an example, comprises at least one headlamp with a plurality of lighting elements, wherein the light intensity of each of the lighting elements can be controlled, in particular dimmed, individually, i.e. independently of one another. The individual lighting elements, for example a number of the lighting elements or all available lighting elements, can be arranged side by side, for example in relation to a surface which can be designed as a flat surface or as a curved surface. In particular, a number of lighting elements can be arranged side by side in a horizontal direction. The lighting device according to the invention comprises a control device which is designed to carry out a method according to the invention described above. The lighting device according to the invention has the features and advantages already mentioned in connection with the method according to the invention. It can comprise a device for detecting bodies (i.e., objects or subjects) to be protected against glare, such as other road users, in particular.

The lighting elements can generally comprise LEDs (wherein an LED is a light-emitting diode). In principle, any type of segmented lighting technology can be used. This means that light blocking technologies (e.g., LCD, DMD) that are capable of generating a segmented or individually controllable light distribution can also be used. The lighting elements can be arranged in the form of a matrix (i.e., a light source matrix).

The vehicle according to the invention comprises a previously described lighting device according to the invention. The vehicle according to the invention has the advantages already described. The vehicle can be a motor vehicle, bicycle, rail-guided vehicle, aircraft or ship. The motor vehicle can be a passenger car, a truck, a bus, a minibus, a motorcycle, or moped.

A computer-implemented method according to the invention comprises commands, which during the execution of the program by a computer cause the computer to carry out a method according to the invention described above. The computer program product according to the invention comprises commands, which during the execution of the program by a computer cause the computer to carry out a method according to the invention described above. The computer program product according to the invention is stored on the computer-readable data carrier according to the invention. A data carrier signal according to the invention can also be used to transmit the computer program product according to the invention. The computer-implemented method according to the invention, the computer program product according to the invention, the computer-readable data carrier according to the invention, and the data carrier signal according to the invention have the above-mentioned features and advantages.

The invention is described hereafter in greater detail on the basis of exemplary embodiments and by reference to the attached drawings. Although the invention is illustrated and described in greater detail by means of the preferred exemplary embodiments, the invention is not restricted by the examples disclosed and other variations can be derived therefrom by the person skilled in the art without departing from the scope of protection of the invention.

The figures are not necessarily accurate in every detail or true to scale and can be shown enlarged or reduced in order to provide a better overview. Therefore, functional details disclosed here are not to be understood in a restrictive sense, but merely as a descriptive basis which offers guidance to the person skilled in the art in this field of technology for applying the present invention in a variety of ways.

As used herein, the term “and/or”, when used in a series of two or more elements, means that each of the items listed can either be used alone, or else any combination of two or more of the listed elements can be used. For example, if a combination is described which contains the components A, B, and/or C, the combination can contain A alone; B alone; C alone; A and B in combination; A and C in combination; B and C in combination; or A, B, and C in combination.

### BRIEF DESCRIPTION OF THE DRAWINGS

FIG. 1 is a schematic diagram of a road surface with two motor vehicles, viewed from above.

FIG. 2 is a schematic diagram of a lighting device for a vehicle in an exploded view.

FIG. 3 is a schematic diagram in the form of a flowchart of a method according to the invention for operating a lighting device for a vehicle.

FIG. 4 is a schematic diagram of a first variant of a generated illumination of an oncoming vehicle from the perspective of the illuminating vehicle in the direction of travel.

FIG. 5 is a schematic diagram of a second variant of a generated illumination of an oncoming vehicle from the perspective of the illuminating vehicle in the direction of travel.

FIG. 6 is a schematic diagram that illustrates the light intensity of a lighting element as a function of the angular distance of the angle segment illuminated by a lighting element for different sizes of the transition angular range.

FIG. 7 is a schematic drawing of a lighting device according to the invention.

FIG. 8 is a schematic drawing of a vehicle according to the invention.

### DETAILED DESCRIPTION OF PREFERRED EMBODIMENTS

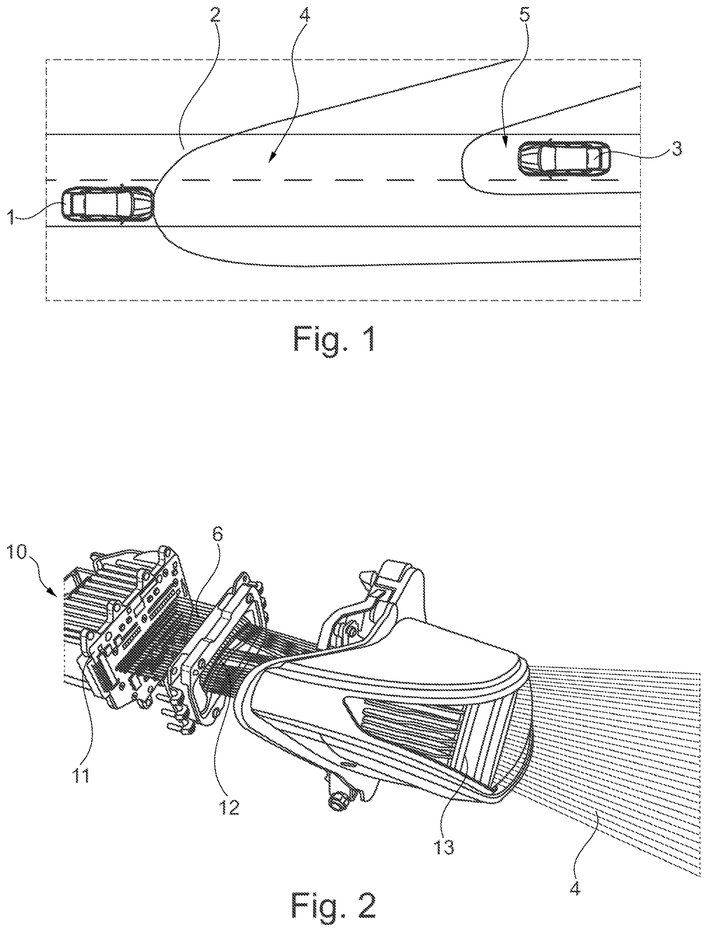

FIG. 1 shows a schematic diagram of a road surface 2 with two motor vehicles 1 and 3 viewed from above. The first motor vehicle 1 has its main beam switched on. The second motor vehicle 3 is traveling towards the first motor vehicle 1 in an opposing lane. The light beam emitted by the main beam of the first motor vehicle 1 is labeled with the reference numeral 4. The light beam of the main beam normally causes glare to a user of the second motor vehicle 3. The region labeled with reference numeral 5 should therefore be protected from glare. This can be realized in an advantageous way by means of the present invention.

FIG. 2 shows a schematic diagram of a lighting device 10 for a vehicle in an exploded view. The lighting device 10 comprises a printed circuit board 11 with a plurality of LED chips, for example with 84 LED chips, which are each individually mounted and integrated into a control unit. The light emitted by the LEDs 6 is manipulated in a primary optics 12, which can comprise silicone, for example, and directed to a secondary optics 13, which can comprise PMMA lenses, for example. The light emitted by the lighting device 10 can provide the main light beam and is labeled with the reference numeral 4.

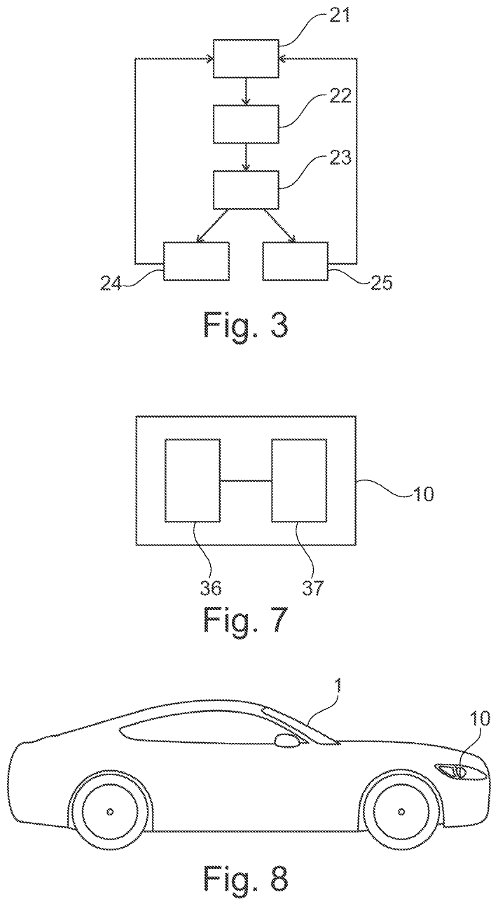

In the following, a method according to the invention is explained in more detail using the flowchart shown in FIG. 3. In a first step 21, an activated state of the at least one headlamp 10 is detected. In a second step 22, a body to be protected is from glare is detected. This can be effected using suitable sensors, such as cameras, in particular mono, stereo, or infrared cameras, and/or ultrasonic sensors and/or radar sensors and/or lidar sensors. The body to be protected from glare can in principle be any object or subject, for example one or more other road users, in particular another vehicle (see vehicle 3 in FIG. 1). Bodies to be protected from glare can be identified by means of a camera on the basis of their lighting devices. As part of the image processing, light sources are evaluated and objects are identified on the basis of their edges, wherein both types of information can be evaluated together.

In step 23, a glare suppression angular range 5 is determined based on a determined extent of the detected body. The extent can be determined from detected geometric parameters such as the width of the body and/or from the position of one or more of the detected lighting devices of the body. Also in step 23, at least one transition angular range, adjacent to the glare suppression angular range, to a fully illuminated angular range is determined.

In step 24, the light intensity of the lighting elements, for example the corresponding LEDs, illuminating the glare suppression angular range is controlled to a light intensity below a specified limit For example, the limit may be below 10% of the maximum light intensity. The corresponding lighting elements can also be switched off or deactivated.

In step 25 (which can be carried out simultaneously, before, or after step 24), the light intensity of the lighting elements illuminating the transition angular range is controlled to a light intensity which depends on the distance, in particular the angular distance, of the beam angle of the individual lighting elements from the glare suppression angular range. The light intensity increases with increasing distance. In the variant shown in FIG. 3, steps 24 and 25 are executed simultaneously. Thereafter, the method branches back to step 21. Alternatively, the method can alternatively branch back to step 22. If the method branches back to step 22, the method is repeated until an input is received to terminate the method. This can be the case, for example, when a headlamp is switched off or a corresponding user input is detected.

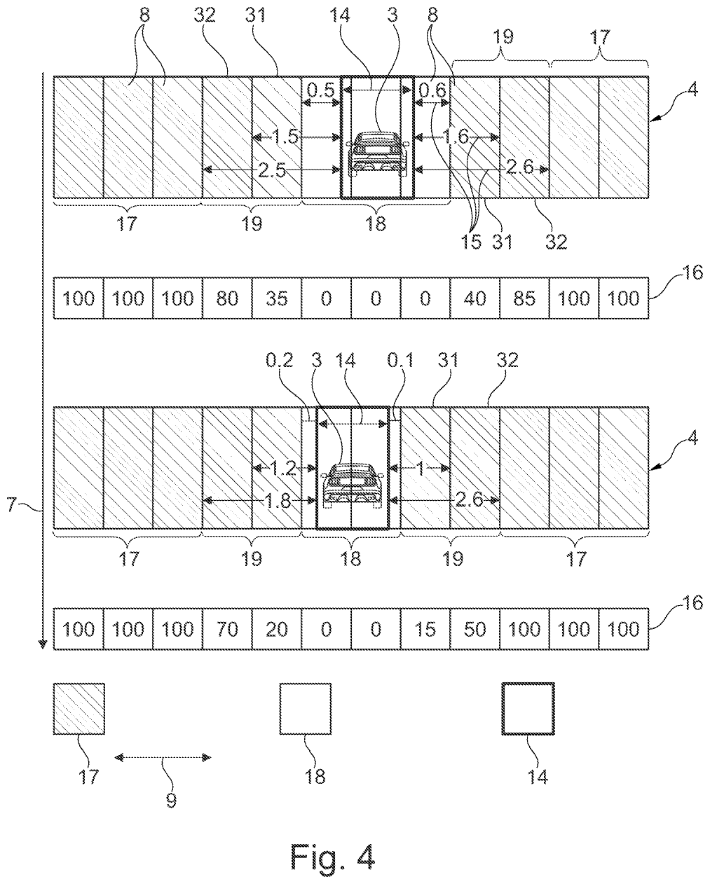

In the following, variant embodiments of steps 24 and 25 are explained in more detail using FIGS. 4 to 6. FIG. 4 shows two example snapshots, shown schematically one above the other, of portions of an illumination beam directed toward an oncoming vehicle 3 as generated by corresponding elements of the lighting device, in a front view. The chronological sequence is indicated by an arrow 7. In the variant shown, the individual lighting elements of the lighting device are divided into segments arranged next to one another in the x-direction 9, for example horizontally. Each segment illuminates a specified angular range 8, hereafter referred to as a beam angle segment or angle segment. The angle segments 8 can be of equal size, but they can also have different sizes. Likewise, angular ranges of individual segments can overlap, which for the sake of simplicity is not shown here.

In step 23 of the method described in FIG. 3, based on a determined extent of the vehicle 3 detected in this example, a glare suppression angular range is determined which is labeled in FIG. 4 with the reference numeral 14. Each respective distance 15, in particular the respective angular distance, of a boundary of the respective illumination angle of the individual angle segments 8 is then determined. In the variant shown at the top of FIG. 4, the boundary measured from the glare suppression angular range 14 of a first angle segment 8 shown to the right of the motor vehicle 3 has an angular distance of 0.6 degrees, that of a second angle segment has an angular distance of 1.6 degrees and that of a third angle segment has an angular distance of 2.6 degrees. The boundary measured from the glare suppression angular range 14 of a first angle segment 8 shown to the left of the motor vehicle 3 has an angular distance of 0.5 degrees, that of a second angle segment has an angular distance of 1.5 degrees and that of a third angle segment has an angular distance of 2.5 degrees. Depending on each respective angular distance, the light intensity of the individual lighting elements of the respective segments is controlled. In the row 16 shown below the angle segments 8, a light intensity emitted by each segment is indicated as a percentage of the full, unmodified intensity. For visualization purposes, the angle segments 8 which generate a fully illuminated (i.e., non-dimmed) angular range are indicated by reference numeral 17, and angle segments 8 which generate a glare suppression (i.e., deactivated or 0% intensity) angular range are indicated by reference numeral 18. Between the glare suppression angular range 18 and the fully illuminated angular range 17, a transition (i.e., dimmed) angular range 19 is formed, the size of which can be individually defined and dynamically adjusted. Lighting elements that illuminate the transition angular range 19 show an increasing light intensity with increasing angular distance x from the glare suppression angular range 18. In the variant shown in FIG. 4, a first transition angular sub-range 31 and a second transition angular sub-range 32 are provided for this range, each of which is formed by a respective angle segment 8. The first transition angular sub-range 31 in each case is adjacent to the glare suppression angular range 18 or an angle segment 8 that encompasses it. The second transition angular range 32 is adjacent to the first transition angular sub-range 31 in the direction approaching the fully illuminated angular range 17. The lighting elements that illuminate the second transition angular sub-range 32 each have a higher light intensity than the lighting elements that illuminate the first transition angular sub-range 31.

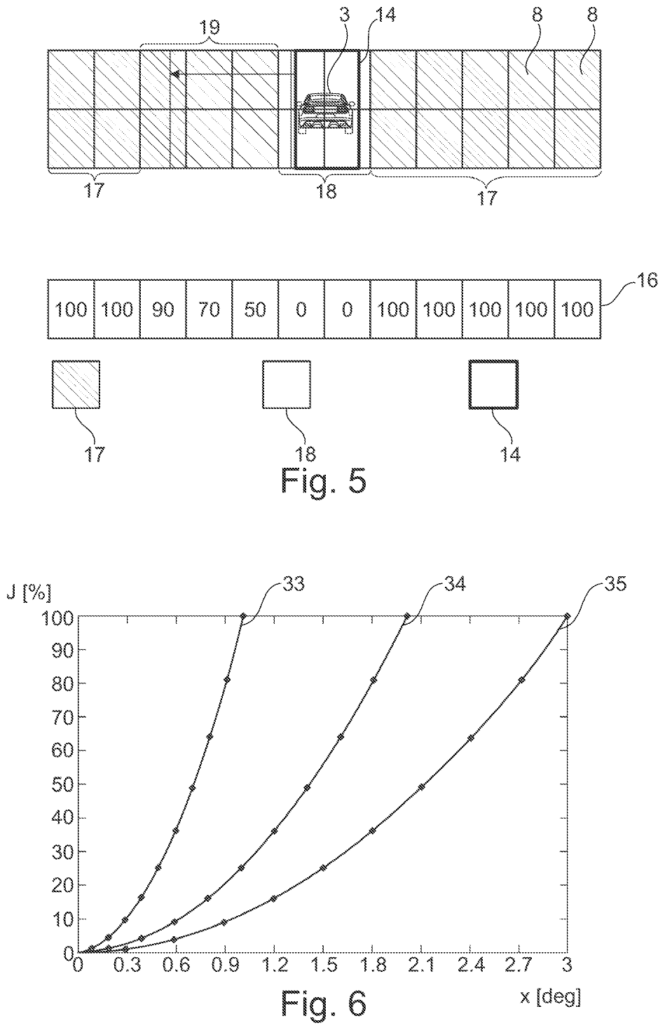

In the variant shown in FIG. 5, only one transition angular range 19 is present, which in the variant shown to the left of the motor vehicle 3 is arranged between the glare suppression angular range 14 and the fully illuminated angular range 17. The transition angular range 19 comprises three angle segments 8 with increasing light intensity in the direction of the fully illuminated angular range 17.

FIG. 6 shows a schematic diagram showing the light intensity J in percent of a lighting element or of the lighting elements of a segment as a function of the angular distance x in degrees of the angle segment 8 illuminated by the lighting element or the lighting elements for different sizes of the transition angular range. The curve 33 is plotted for a size of a transition angular range of 1 degree. The curve 34 is plotted for a size of a transition angular range of 2 degrees. The curve 35 is plotted for a size of a transition angular range 19 of 3 degrees. Depending on the chosen size of the transition angular range 19, which can be dynamically adjusted, the light intensity J of the individual lighting elements can be controlled as a function of the distance of is the angular range illuminated by them from the glare suppression angular range 14.

FIG. 7 shows a schematic drawing of a lighting device 10 according to the invention for a vehicle 1. The lighting device 10 comprises a plurality of lighting elements 36, for example LEDs, and a control device 37 for controlling the light intensity emitted by each lighting element. The control device 37 is designed to carry out a method according to the invention, for example a method according to the invention described by means of FIGS. 3 to 6.

FIG. 8 shows a schematic drawing of a vehicle 1 according to the invention, for example a motor vehicle according to the invention. The vehicle 1 according to the invention comprises a previously described lighting device 10 according to the invention.

### LIST OF REFERENCE SIGNS

1 motor vehicle
2 road surface
3 motor vehicle
4 emitted light
5 glare suppression region
6 emitted light
7 chronological sequence
8 angle segment
9 x-direction
10 lighting device
11 printed circuit board with LEDs
12 primary optics
13 secondary optics
14 glare suppression angular range
15 angular distance
16 emitted light intensity
17 fully illuminated angular range
18 glare suppression angular range
19 transition angular range
21 headlamp switched on
22 body to be protected from glare
23 Determine glare suppression angular range based on a determined extent of the detected body and determine transition angular range
24 Control the light intensity of the lighting elements illuminating the glare suppression angular range to a light intensity below a specified limit
25 Light intensity of the lighting elements illuminating the transition angular range controlled to a light intensity which depends on the distance from the beam angle of the individual lighting elements to the glare suppression angular range
31 first transition angular range
32 second transition angular range
33 curve
34 curve
35 curve
36 plurality of lighting elements
37 control device

What is claimed is:

1. A method for operating a lighting device for a vehicle, wherein the lighting device comprises at least one headlamp having a plurality of lighting elements, wherein a light intensity of each lighting element is individually controllable, the method comprising the steps of:
detecting an activated state of the at least one headlamp;
detecting a body to be protected from glare;
determining a glare suppression angular range based on a determined extent and position of the detected body;
determining at least one transition angular range adjacent to the glare suppression angular range;
controlling the light intensity of the lighting elements illuminating the glare suppression angular range to below a specified limit; and
controlling the light intensity of the lighting elements illuminating the transition angular range according to a distance of a respective beam angle of light generated by individual lighting elements from the glare suppression angular range, wherein the light intensity increases as the distance increases.

2. The method according to claim 1 wherein the at least one transition angular range adjacent is between the glare suppression angular range and a fully illuminated angular range.

3. The method according to claim 1 wherein the recited steps are repeated continuously.

4. The method according to claim 1 wherein the distance is an angular distance, wherein the light intensity of at least one lighting element which illuminates at least one transition angular range is controlled as a function of the respective angular distance of the respective beam angle of the lighting element from an angular limit of the glare suppression angular range according to a predetermined curve.

5. The method according to claim 4 wherein the predetermined curve is selected from a plurality of curves according to a specified size of the respective transition region.

6. The method according to claim 1 wherein:
the transition angular range comprises at least one first angular range adjacent to the glare suppression angular range and at least one second angular range adjacent to the first angular range in the direction of the fully illuminated angular range; and
the light intensity of the lighting elements illuminating the first angular range is controlled to between 10 percent and 50 percent of the light intensity of the lighting elements illuminating the fully illuminated angular range, and the light intensity of the lighting elements illuminating the second angular range is controlled to between 50 percent and 90 percent of the light intensity of the lighting elements illuminating the fully illuminated angular range.

7. The method according to claim 1 wherein the lighting elements are assigned to defined beam angle segments, and wherein the light intensity of the lighting elements assigned to a same one of the beam angle segments is controlled as a function of an angular distance of the beam angle segment from the boundary of the glare suppression angular range.

8. The method according to claim 7 wherein the light intensity of the lighting elements that are assigned to the same one of the beam angle segments is controlled as a function of the angular distance of the segment boundary from the boundary of the glare suppression angular range according to a predetermined curve.

9. The method according to claim 1 wherein a size of the at least one transition angular range is adjusted based on an angular velocity of a change in the position or the size of the glare suppression angular range.

10. A lighting device for a vehicle adapted to illuminate a road, comprising:
at least one headlamp having a plurality of lighting elements, wherein a light intensity of each lighting element is individually controllable;
a sensor configured to detect another user of the road; and
a controller configured for:
(A) detecting an activated state of the at least one headlamp;
(B) detecting a body of the another user which is to be protected from glare;
(C) determining a glare suppression angular range based on a determined extent and position of the detected body;
(D) determining at least one transition angular range adjacent to the glare suppression angular range;
(E) controlling the light intensity of the lighting elements illuminating the glare suppression angular range to below a specified limit; and
(F) controlling the light intensity of the lighting elements illuminating the transition angular range according to a distance of a respective beam angle of light generated by individual lighting elements from the glare suppression angular range, wherein the light intensity increases as the distance increases.

11. The lighting device according to claim 10 wherein the lighting elements are comprised of LEDs.

12. The lighting device according to claim 10 wherein the lighting elements are arranged in the form of a matrix.

13. The lighting device according to claim 10 wherein the at least one transition angular range adjacent is between the glare suppression angular range and a fully illuminated angular range.

14. The lighting device according to claim 10 wherein the distance is an angular distance, wherein the light intensity of at least one lighting element which illuminates at least one transition angular range is controlled as a function of the respective angular distance of the respective beam angle of the lighting element from an angular limit of the glare suppression angular range according to a predetermined curve.

15. The lighting device according to claim 14 wherein the predetermined curve is selected from a plurality of curves according to a specified size of the respective transition region.

16. The lighting device according to claim 10 wherein:
the transition angular range comprises at least one first angular range adjacent to the glare suppression angular range and at least one second angular range adjacent to the first angular range in the direction of the fully illuminated angular range; and
the light intensity of the lighting elements illuminating the first angular range is controlled to between 10 percent and 50 percent of the light intensity of the lighting elements illuminating the fully illuminated angular range, and the light intensity of the lighting elements illuminating the second angular range is controlled to between 50 percent and 90 percent of the light intensity of the lighting elements illuminating the fully illuminated angular range.

17. The lighting device according to claim 10 wherein the lighting elements are assigned to defined beam angle segments, and wherein the light intensity of the lighting elements assigned to a same one of the beam angle segments is controlled as a function of an angular distance of the beam angle segment from the boundary of the glare suppression angular range.

18. The lighting device according to claim 17 wherein the light intensity of the lighting elements that are assigned to the same one of the beam angle segments is controlled as a function of the angular distance of a segment boundary from the boundary of the glare suppression angular range according to a predetermined curve.

19. The lighting device according to claim 10 wherein a size of the at least one transition angular range is adjusted based on an angular velocity of a change in the position or the size of the glare suppression angular range.
